(19) United States
(12) Patent Application Publication
(10) Pub. No.: US 2024/0375981 A1
(43) Pub. Date: Nov. 14, 2024

(54) METHOD AND APPARATUS FOR PROCESSING LIQUID WASTE STREAMS

(71) Applicant: KNIGHTHAWK ENGINEERING, INC., Houston, TX (US)

(72) Inventors: Clifton T. KNIGHT, League City, TX (US); Aaron KNIGHT, League City, TX (US); David CARPENCY, Webster, TX (US); Arthur R. DINICOLANTONIO, Houston, TX (US); Kobus STADLER, Parys (ZA)

(21) Appl. No.: 18/655,111

(22) Filed: May 3, 2024

Related U.S. Application Data
(60) Provisional application No. 63/465,173, filed on May 9, 2023.

(51) Int. Cl. C02F 1/72; B01J 6/00; B01J 19/26; C01B 3/36; C02F 1/02; C02F 1/04; C02F 1/58; C02F 101/36; C02F 103/06

(52) U.S. Cl. CPC C02F 1/72; B01J 6/008; B01J 19/26; C01B 3/363; C02F 1/025; C02F 1/048; C02F 1/583; C01B 2203/0233; C01B 2203/0255; C01B 2203/0283; C01B 2203/06; C01B 2203/0822; C01B 2203/1211; C01B 2203/80; C02F 2101/36; C02F 2103/06; C02F 2201/002

(57) ABSTRACT

A PFA removal system includes a torch reaction zone and an organic compound stream, the organic compound stream injected into the torch reaction zone. The PFA removal system also includes a hydrogen stream, the hydrogen stream injected into the torch reaction zone and an oxygen stream, the oxygen stream injected into the torch reaction zone. In addition, the PFA removal system includes a hot waste stream injected into the torch reaction zone and a flue gas stream, the flue gas stream discharged from the torch reaction zone.

### CROSS-REFERENCE TO RELATED APPLICATIONS

This application is a nonprovisional application which claims priority from U.S. provisional application No. 63/465,173, filed May 9, 2023, which is incorporated by reference herein in its entirety.

### TECHNICAL FIELD/FIELD OF THE DISCLOSURE

The present disclosure relates generally to processing of liquid waste streams.

### BACKGROUND OF THE DISCLOSURE

Per- and polyfluoroalkyls (PFAs), including perfluorooctane sulfonic acid (PFOS) and perfluorooctanoic acid (PFOA), are often referred to as “forever chemicals” because they do not naturally degrade. PFAs are known to impact ecological and human health, particularly because PFAs may accumulate in the food chain and affect development in children and increase risk of cancer. PFAs are used in a variety of products and are used to make coatings and products that resist heat, oil, stains, grease and water and are found in a variety of products from clothing and furniture to food packaging and non-stick cooking surfaces. These forever chemicals are often found in wastewater and other liquid waste streams. Traditional methods have been cost ineffective in removing PFAs from wastewater and other liquid waste streams.

### SUMMARY

The disclosure includes a per- and polyfluoroalkyls (PFA) removal system. The PFA removal system includes a torch reaction zone and a organic compound stream, the organic compound stream injected into the torch reaction zone. The PFA removal system also includes a hydrogen stream, the hydrogen stream injected into the torch reaction zone and an oxygen stream the oxygen stream injected into the torch reaction zone. In addition, the PFA removal system includes a hot liquid waste stream injected into the torch reaction zone and a flue gas stream, the flue gas stream discharged from the torch reaction zone.

The disclosure also includes a PFA removal process. The PFA removal process includes introducing an organic compound stream, a hydrogen stream and an oxygen stream into a torch reaction zone and reacting the organic compound stream, the hydrogen stream, and the oxygen stream in the torch reaction zone to form a hydrogen-organic compound torch. The PFA removal process also includes reacting a hot waste stream in the torch reaction zone to form a flue gas stream and discharging the flue gas stream from the torch reaction zone.

The disclosure further includes a torch reactor, the torch reactor being a cylinder, the cylinder having a side wall, a circumference, a closed end and an open end. The torch reactor includes a organic compound entry port, the organic compound entry port extending through the closed end and a hydrogen injection port positioned along the circumference of the cylinder. In addition, the torch reactor includes an oxygen entry port along the circumference of the cylinder and a hot waste stream port, along the circumference of the cylinder.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a flow sheet of PFA removal system consistent with certain embodiments of the present disclosure.

FIG. 2 is a cutaway view of a torch reactor.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

In certain embodiments of the present disclosure, a PFA-containing liquid waste stream, such as, for example and without limitation, wastewater, landfill leachate, or an industrial waste stream, may be injected into an organic compound/hydrogen torch reaction zone, where the PFAs and other hydrocarbons are reacted to form synthesis gas (syngas), which may be composed of hydrogen and carbon monoxide, and a treated liquid waste stream. In some embodiments, the liquid waste stream may be or is an aqueous stream. In certain embodiments, both the syngas and the treated liquid waste stream may be recovered for use in industrial processes and irrigation, for example, respectively.

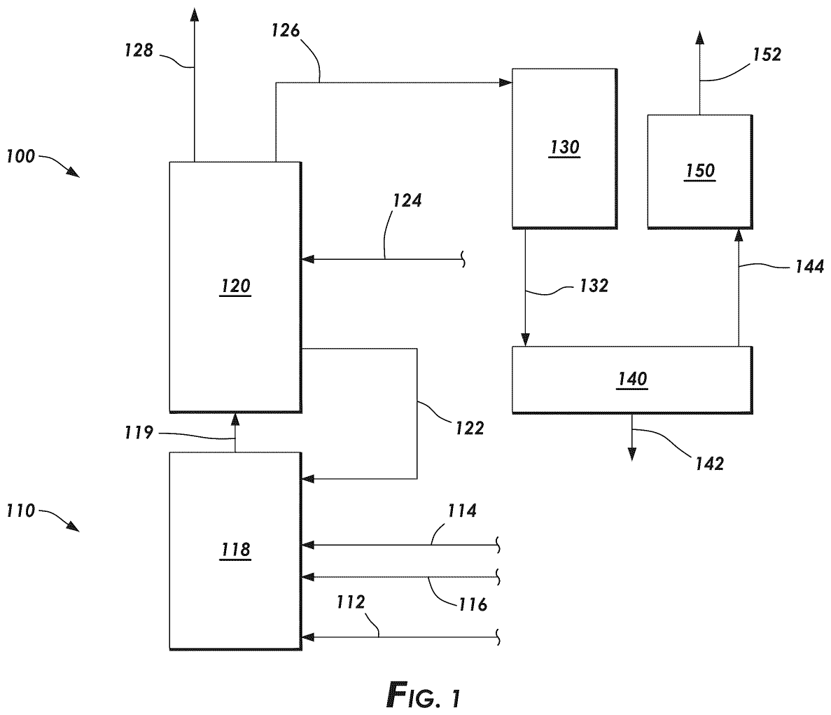

FIG. 1 depicts a flow sheet of PFA removal system 100 in accordance with at least one embodiment of the present disclosure. PFA removal system 100 includes torch reaction zone 110. In torch reaction zone 110, organic compound stream 112 and hydrogen stream 114 are injected into torch reaction zone 110, along with oxygen stream 116. The organic compound may be, for example, a hydrocarbon, (such as methane). A higher hydrocarbon content of the organic compound may reduce the volume of hydrocarbon stream 114. The organic compound from organic compound stream 112 and the hydrogen from hydrogen stream 114 are reacted with the oxygen from oxygen stream 116 within torch reaction zone 110 to form hydrogen-organic compound torch 118.

The liquid waste stream may be heated to form hot waste stream 122. Hot waste stream 122 may be a liquid stream, a liquid-gas equilibrium stream, or a super-heated gas stream. In certain embodiments, hot waste stream 122 is introduced into torch reaction zone 110 and reacted in hydrogen-organic compound torch 118. Hot waste stream 122 may include liquid and entrained solids or may include liquid in equilibrium with gas and solids or may be a superheated gas stream and solids. The material in hot waste stream 122 may include water and various organics, including for example and without limitation, adipates, amides, naphthenics, aldehydes, aromatics, PFAs, and phenol. As one of ordinary skill in the art would appreciate with the benefit of this disclosure, the type and amount of organics in hot waste stream 122 is dependent upon the source of the waste and may vary from the examples provided herein. After reaction, the hot waste from hot waste stream 122 forms flue gas stream 119. Flue gas stream 119 may include, for example and without limitation, syngas, hydrogen organic compounds such as methane, oxygen, carbon dioxide, steam, and entrained flue gas solids. In certain embodiments, the concentration of PFAs in hot waste stream 122 is reduced by at least 97%.

In certain embodiments, such as the embodiment shown in FIG. 1, flue gas stream 119 may be cooled in heat exchanger 120. Heat exchanger 120 exchanges waste heat from flue gas stream 119 with cold liquid waste stream 124 to form hot waste stream 122, described above. Heat exchanger 120 may be of any type of heat exchanger adapted to exchange heat between a liquid and gas including, for example, shell and tube, double tube, plate, or shell and coil.

In certain embodiments, the cooled flue gas may be exhausted from heat exchanger 120 in exhaust gas stream 128. In other embodiments, cooled flue gas stream 126 is processed to recover the syngas and treated waste. Cooled flue gas stream 126 may be passed through condenser 130 to form wet flue gas stream 132. In certain non-limiting embodiments, condenser 130 may be a down flow condenser. Wet flue gas stream 132 may include treated waste and syngas. Wet flue gas stream 132 may then be introduced into vapor liquid separator 140 where condensate stream 142 is separated from dry flue gas stream 144. Dry flue gas stream 144 may be analyzed in gas analyzer 150 and syngas stream 152 may be sent for use in industrial processes. Condensate stream 142 may be used as treated waste in suitable applications such as irrigation.

As one of ordinary skill in the art with the benefit of this disclosure will appreciate that the ratio of syngas produced to PFAs destroyed may be adjusted. For example, to increase the amount of PFAs destroyed, the flow rate of the liquid waste stream is increased and the amount of hydrogen and oxygen is throttled to achieve a lower temperature. By contrast, if the goals is to target a certain flow rate of syngas, the flow rate of the liquid waste stream is reduced to achieve the target flow rate of syngas.

Without being bound by theory, it is believed that steam reforming, partial oxidation, and water gas shift occur within torch reaction zone 110.

Steam Reforming

CH₄+H₂O [symbol] CO+3H₂

Partial Oxidation

2CH₄+O₂→2CO+4H₂

Water Gas Shift

CO+H₂O [symbol] CO₂+H₂

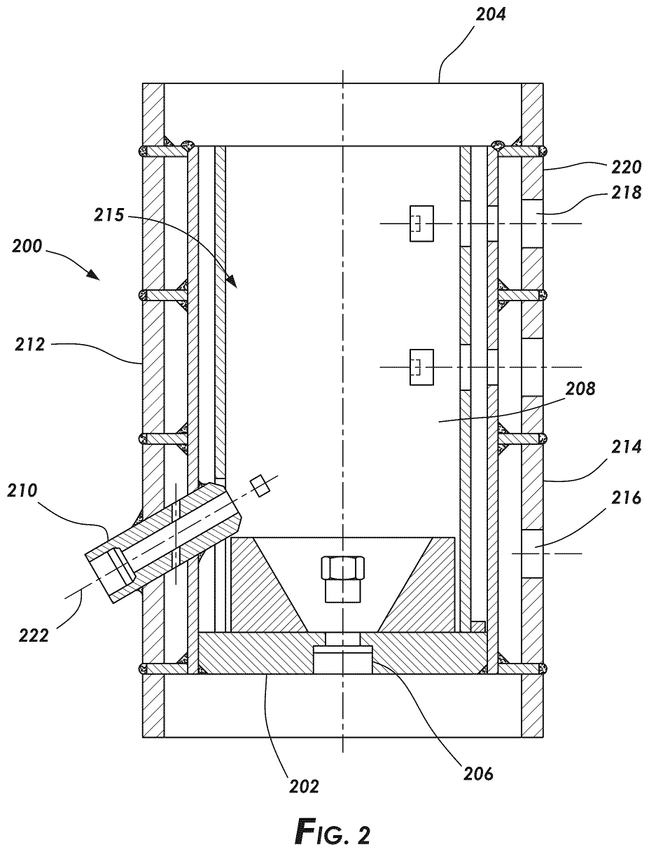

Torch reactor 200, used in certain embodiments for torch reaction zone 110, is shown in cutaway in FIG. 2. In the embodiment shown in FIG. 2, torch reactor 200 is cylindrical, although other configurations are contemplated by this disclosure. Torch reactor 200 may have closed end 202 and open end 204. Organic compound entry port 206 may extend through closed end 202 into interior chamber 208 of torch reactor 200. Hydrogen injection ports 210 may be formed in side wall 212 of torch reactor 200. In certain embodiments, multiple hydrogen injection ports 210 may be formed in side wall 212 about circumference 214 of torch reactor 200. In certain embodiments, torch reactor 200 may include between 2 and 10 hydrogen injection ports 210. In some embodiments, centerline 222 of hydrogen injection port 210 may be at an angle of less than 90 degrees to side wall 212.

As further shown in FIG. 2, torch reactor 200 may include at least one oxygen entry port 216. Oxygen entry ports 216 may be positioned about circumference 214 of torch reactor 200. In certain embodiments, torch reactor 200 may also include secondary oxygen ports 218. Secondary oxygen ports 218 may be positioned about circumference 214 of torch reactor 200. Secondary oxygen ports 218 may be positioned at a distance further away from closed end 202 than oxygen entry ports 216.

Hot liquid ports 220 may be positioned about circumference 214 of torch reactor 200, further from closed end 202 than hydrogen injection ports 210, oxygen entry ports 216 and, when present, secondary oxygen ports 218.

In certain embodiments, an outside of side wall 212 may be lined with a high temperature insulator 215, such as rhenium.

### EXAMPLES

### Example 1

A demonstration unit (HTR-DU) consistent with PFA removal system 100 and torch reactor 200 was constructed and used with wastewater to determine effectiveness. The demonstration unit was manufactured as a 4″ diameter bore for the location of core reactions.

During the test, the wastewater was well mixed, and then the wastewater pump was brought online. The pump collected mixed wastewater and pumped the mixed wastewater through a preheat coil heat exchanger around the HTR-DU stack, and subsequently through an injection nozzle directly into the HTR-DU reaction zone.

A sampling system was installed to allow for the extraction of a hot raw gas sample from the top of the HTR-DU reactor outlet. The sample was cooled indirectly via a coiled tube through an ice bath in a downflow configuration. The cooled gas and condensate were separated in a gas-liquid separator where the condensate was accumulated in the sump, and the syngas flowed to an overhead outlet. This cool, vapor syngas stream was routed via an online gas analyzer to report vol % O₂, CO₂, CO, H₂, and CH₄. Calibration tests by known gas samples were performed before, during, and after test runs to confirm analyzer calibration accuracy. The vapor-liquid separator was kept sealed, able to collect condensate, until the end of the test where condensate was drained into a condensate sample collection bottle.

Feed flows were managed as set forth below in Table 1. Dried Flue gas readings are also shown in Table 1:

TABLE 1

| Parameter | | HTR-DU | |
|---|---|---|---|
| O₂ Secondary | SCFM (gmol/min) | 0.00 | (0.00) |
| O₂ Primary | SCFM (gmol/min) | 1.90 | (2.20) |
| H₂ Flow | SCFM (gmol/min) | 1.02 | (1.18) |
| CH₄ Flow | SCFM (gmol/min) | 1.27 | (1.47) |
| Liquid injection rate | gal/hour | 2.5 | (8.7) |

| | | |
|---|---|---|
| (gmol/min) | | |
| Volume Fraction O₂ | vol % | 0.0 |
| Volume Fraction CO | vol % | 29.7 |
| Volume Fraction CO₂ | vol % | 5.8 |
| Volume Fraction CH₄ | vol % | 5.1 |
| Volume Fraction H₂ | vol % | 59.4 |

Syngas Production and Ratios are shown below in Table 2:

TABLE 2

| Metric | Measurement | HTR-DU |
|---|---|---|
| Syngas mol % | (H₂ + CO) of total product | 23.1% |
| Syngas mol % | (H₂ + CO) of dry product | 89.1% |
| H₂:H₂ molar ratio | H₂ in Product/H₂ in Feed | 1.83 |
| H₂:CH₄ molar ratio | H₂ produced/CH₄ consumed | 0.76 |
| H₂:CO molar ratio | Product H₂:CO ratio | 2.00 |
| Temperature ° F. | External Metal skin (Outer Wall) | 1840 |

Measurements of PFAs were performed in both the wastewater and in the resulting condensate, as shown in Table 3 below:

TABLE 3

| | | | HTR-Processed | |
|---|---|---|---|---|
| | Raw Wastewater | HTR-Processed | Adjusted | |
| | Concentration | Concentration | Concentration | |
| Compound | (ng/L) | (ng/L) ¹ | (ng/L) | % Destroyed |
| Perfluorooctanoic | 406 | 2.17* | 2.62* | 99.4% |
| acid (PFOA) | | | | |
| Perfluorooctanesulfonic | 222 | 3.52* | 4.26* | 98.1% |
| acid (PFOS) | | | | |
| Perfluorodecanoic acid | 23.9 | ND | ND | Destroyed to |
| (PFDA) | | | | Non-Detect |
| Perfluorohexanoic | 135 | ND | ND | Destroyed to |
| acid (PFHxA) | | | | Non-Detect |
| Perfluoropentanoic | 162 | ND | ND | Destroyed to |
| acid (PFPeA) | | | | Non-Detect |
| Perfluorobutanesulfonic | 73.1 | ND | ND | Destroyed to |
| acid (PFBS) | | | | Non-Detect |
| Perfluorobutanonic | 532 | 29.9 | 36.1 | 93.2% |
| acid (PFBA) | | | | |
| 6:2 Fluorotelomer | 129 | ND | ND | Destroyed to |
| sulfonic acid (6:2 FTS) | | | | Non-Detect |

With regard to Table 3, a concentration reported as Not Detected (ND) means that the value is below the Limit of Detection (DL), a value that is specific to each test and constituent, but is most often about 2-3 ng/L. For non-detect results, while the level of constituent destruction cannot be exactly determined, the results nevertheless indicate very effective destruction of the constituent. Also, the 4^{th} column of Table 3 is adjusted to discount the dilution provided by water generation as a result of the chemical reactions used as a metric for calculating values in the 5^{th} column.

For Table 3, * indicates that the measured value is very low and is less than the Limit of Quantification (LoQ), indicating minor uncertainty to the exact concentration of the constituent.

Particulates in the wastewater and in the condensate were tested by exposure to a butane torch's flame. The particulates from the wastewater were combustible and exhibited significant smoldering and smoking. In contrast, particulates from the condensate did not experience a reaction from exposure to the butane torch other than heating.

### Example 2

The apparatus from Example 1 was used as in Example 1 for startup water (clean water) and a second type of wastewater (KHEP). Feed flows and dried flue gas readings are set forth below in Table 4:

TABLE 4

| Parameter | | Startup Water | | KHEP | | Delta |
|---|---|---|---|---|---|---|
| O₂ Secondary | SCFM | 0.2 | (0.23) | 0.2 | (0.23) | = |
| | (mol/min) | | | | | |
| O₂ Primary | SCFM | 1.6 | (1.85) | 1.6 | (1.85) | = |
| | (mol/min) | | | | | |
| H₂ Flow | SCFM | 0.73 | (0.85) | 0.73 | (0.85) | = |
| | (mol/min) | | | | | |
| CH₄ Flow | SCFM | 1.84 | (2.13) | 1.83 | (2.13) | = |
| | (mol/min) | | | | | |

| | | | | |
|---|---|---|---|---|
| Liquid | gal/hour | 1.6 | 1.6 | = |
| Injection rate | | | | |
| Volume | % Xv | 0.2% | 0.0% | −0.2% |
| Fraction O₂ | | | | |
| Volume | % Xv | 30.8% | 30.9% | +0.1% |
| Fraction CO | | | | |
| Volume | % Xv | 5.7% | 5.7% | = |
| Fraction CO₂ | | | | |
| Volume | % Xv | 0.6% | 0.2% | −0.4% |
| Fraction CH₄ | | | | |
| Volume | % Xv | 62.8% | 63.2% | +0.4% |
| Fraction H₂ | | | | |

SCFM is standard cubic feet per minute; equivalent gram-mole/minute are shown in parentheses ( ). Syngas Production and Ratios are shown below in Table 5:

TABLE 5

| | | Startup | | |
|---|---|---|---|---|
| Metric | Measurement | Water | KHEP | Delta |
| Syngas % mol | (H₂ + CO)/ | 42.6% | 43.0% | +0.4% |
| | Total products | | | |
| Syngas % mol | (H₂ + CO)/ | 93.5% | 94.1% | +0.6% |
| | Products dry | | | |
| H₂:H₂ | H₂ in Product/ | 4.24 | 4.29 | +1.1% rel. |
| molar ratio | H₂ in Feed | | | |
| H₂:CH₄ | H₂ produced/ | 1.32 | 1.32 | +0.3% rel. |
| molar ratio | CH₄ consumed | | | |
| H₂:CO | Product H₂:CO | 2.04 | 2.04 | = |
| molar ratio | ratio | | | |
| Temperature ° F. | External | 1650 | 1680 | +30° F. |
| | Metal skin | | | |

The foregoing outlines features of several embodiments so that a person of ordinary skill in the art may better understand the aspects of the present disclosure. Such features may be replaced by any one of numerous equivalent alternatives, only some of which are disclosed herein. One of ordinary skill in the art should appreciate that they may readily use the present disclosure as a basis for designing or modifying other processes and structures for carrying out the same purposes and/or achieving the same advantages of the embodiments introduced herein. One of ordinary skill in the art should also realize that such equivalent constructions do not depart from the spirit and scope of the present disclosure and that they may make various changes, substitutions, and alterations herein without departing from the spirit and scope of the present disclosure.

1. A per- and polyfluoroalkyls (PFA) removal system comprising:
a torch reaction zone;
an organic compound stream, the organic compound stream injected into the torch reaction zone;
a hydrogen stream, the hydrogen stream injected into the torch reaction zone;
an oxygen stream the oxygen stream injected into the torch reaction zone;
a hot waste stream, the hot waste stream injected into the torch reaction zone; and
a flue gas stream, the flue gas stream discharged from the torch reaction zone.

2. The PFA removal system of claim 1, wherein the waste stream includes gas, liquid, and organics.

3. The PFA removal system of claim 1, wherein the organics include PFAs.

4. The PFA removal system of claim 1, wherein the flue gas stream includes syngas.

5. The PFA removal system of claim 1 further comprising a heat exchanger, the heat exchanger adapted to cool the flue gas stream to form a cooled flue gas stream using a cold waste stream to form the hot waste stream.

6. The PFA removal system of claim 5 further including a condenser, the condenser adapted to cool the cooled flue gas stream to form a wet flue gas stream.

7. The PFA removal system of claim 6 further comprising a vapor liquid separator, the vapor liquid separator adapted to separate the wet flue gas stream to a syngas stream and a condensate stream.

8. A per- and polyfluoroalkyls (PFA) removal process comprising:
introducing an organic compound stream, a hydrogen stream and an oxygen stream into a torch reaction zone;
reacting the organic compound stream, the hydrogen stream, and the oxygen stream in the torch reaction zone to form a hydrogen-organic compound torch;
reacting a hot waste stream in the torch reaction zone to form a flue gas stream;
discharging the flue gas stream from the torch reaction zone.

9. The method of claim 8, wherein the hot waste stream comprises PFAs.

10. The method of claim 8, wherein the amount of PFAs in the hot waste stream is reduced by at least 97% by reaction with the hydrogen-organic compound torch.

11. The method of claim 8 further comprising:
exchanging heat in the flue gas stream in a heat exchanger to form a cooled flue gas stream using a cool waste stream to form the hot waste stream.

12. The method of claim 11 further comprising passing the cooled flue gas stream through a condenser to form a wet flue gas stream.

13. The method of claim 12, wherein the condenser is a down flow condenser.

14. The method of claim 11 further comprising separating the wet flue gas stream into a condensate stream and a syngas stream.

15. A torch reactor, the torch reactor being a cylinder, the cylinder having a side wall, a circumference, a closed end and an open end, the torch reactor comprising:
an organic compound entry port, the organic compound entry port extending through the closed end;
a hydrogen injection port positioned along the circumference of the cylinder;
an oxygen entry port along the circumference of the cylinder; and
a hot waste port, along the circumference of the cylinder.

16. The torch reactor of claim 15, wherein the oxygen entry port is further from the closed end than the hydrogen injection port.

17. The torch reactor of claim 15, wherein the hot waste port is further from the closed end than the oxygen entry port.

18. The torch reactor of claim 15 further comprising a secondary oxygen injection port, the secondary oxygen injection port being further from the closed end than the oxygen entry port.

19. The torch reactor of claim 15, wherein the hydrogen injection port is at an angle of less than 90 degrees from the side wall.

20. The torch reactor of claim 15 having a plurality of hydrogen injection ports through the side wall of the cylinder.
